(19) United States
(12) Patent Application Publication
(10) Pub. No.: US 2006/0222920 A1
(43) Pub. Date: Oct. 5, 2006

(54) Metal cations chelators for fuel cells

(76) Inventors: Belabbes Merzougui, Warren, MI (US); Andrew M. Mance, Royal Oak, MI (US); Ion C. Halalay, Grosse Pointe, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/097,112

(22) Filed: Apr. 1, 2005

(51) Int. Cl. H01M 8/10; H01M 4/86

(52) U.S. Cl. 429/30; 429/33; 429/40

(57) ABSTRACT

A fuel cell having a polymer electrolyte membrane containing fluorine atoms distributed along the polymer chains, and metal conductors and/or catalysts. The cell is protected from metal ion degradation of cell components, especially the polymer electrolyte, by a metal ion sequestering or chelating agent fixed in the cell or flowing through the cell. In a preferred embodiment, the metal ion-sequestering agent comprises a suitable number of metal ion-binding molecular crown moieties attached to polymer constituents in the electrolyte membrane or in electrodes.

### TECHNICAL FIELD

The present invention relates to fuel cells with metal components and fluorine containing polymer proton exchange membranes. More specifically this invention relates to the scavenging of harmful metal cations released during cell operation.

### BACKGROUND OF THE INVENTION

Fuel cells are electrochemical cells that are being developed for motive and stationary electric power generation. One fuel cell design uses a solid polymer electrolyte (SPE) membrane or proton exchange membrane (PEM), to provide ion transport between the anode and cathode. Gaseous and liquid fuels capable of providing protons are used. Examples include hydrogen and methanol, with hydrogen being favored. Hydrogen is supplied to the fuel cell's anode. Oxygen (as air) is the cell oxidant and is supplied to the cell's cathode. The electrodes are formed of porous conductive materials, such as woven graphite, graphitized sheets, or carbon paper to enable the fuel to disperse over the surface of the membrane facing the fuel supply electrode. Each electrode carries finely divided catalyst particles to promote ionization of hydrogen at the anode and of oxygen at the cathode. Protons flow from the anode through the ionically conductive polymer membrane to the cathode where they combine with oxygen ions to form water, which is discharged from the cell. Conductor plates carry away the electrons formed at the anode. A typical fuel cell is described in U.S. Pat. No. 5,272,017 and U.S. Pat. No. 5,316,871 (Swathirajan et al).

Currently, state of the art PEM fuel cells utilize a membrane made of perfluorinated ionomers such as DuPont's Nafion. The ionomer carries pendant ionizable groups (e.g. sulfonate groups) for transport of protons through the membrane from the anode to the cathode. But unwanted oxidation reactions occurring within the cell create nucleophilic species which release fluoride anions from the polymer membrane. The fluoride anions react with metal surfaces to release metal cations from the metal conductor plates and catalyst particles. The metal cations occupy ionic sites on the ionomer molecules degrading their proton transport function. Further, ferrous ions react with peroxides to produce hydroxyl radicals adding to the oxidation initiated degradation processes. Such degradation interferes with the conductivity of the membrane and shortens the working life of the fuel cell.

Proposals have been made by the inventors herein to mitigate the effect of the oxidation reactions and presence of fluoride anions. But a need remains for a method of mitigating the effect of the metal cations released by such unwanted side reactions during cell operation.

### SUMMARY OF THE INVENTION

This invention pertains to a way of preserving the stability of an electrolytic cell whose performance is degraded by formation of unwanted metal ions during cell operation. The invention is particularly applicable to preserving the stability of the ionomer found in the electrolyte membrane.

Electrolytic degradation is reduced by scavenging the contaminant metal cations with a very tightly binding chelating agent that is grafted to the ionomer or incorporated in the polymeric chain. The chelating agent may, alternatively, be attached to or incorporated with other polymeric or water insoluble anchoring sites in the cell, particularly in the catalyst layers. These metal ion chelating agents are suitably crown ethers or crown ring containing molecules structurally analogous to or derived from crown ethers, such as thia crowns (in which one or more sulfur atoms replace the oxygen atoms in the crown ether), aza crowns, in which one or more nitrogen atoms replace the oxygen atoms in the crown ether, or other hetero crowns in which one or more coordinating atoms replace the oxygen atoms in the crown ether molecule.

Other organic chelating agents with suitable metal binding characteristics are also useful for these electrolytic cell applications. Additionally, the sequestering agent does not need to be a wholly organic agent. Inorganic structures capable of binding metal ions, such as zeolites, have been attached to organic groups. A zeolite may be functionalized so that it may be incorporated into a polymer as a side chain or as part of the backbone. This concept involving inorganic sequestering agents is not limited to zeolites. Other inorganic units, such as clays, can be utilized. Similarly, anionic or neutral inorganic fibers and tubes may also be utilized if those groups bind tightly to metallic anions. Furthermore, a class of nanocomposite materials known as ceramers or ormosils exists in which inorganic oxide units are incorporated within a polymer. The use of an appropriate inorganic oxide, capable of scavenging cationic contaminants, through either complexation or through an ion exchange process, within such a nanocomposite could also serve to limit conductivity loss in the ionomer.

As stated, it will usually be preferred to suitably anchor the metal ion binding species to an insoluble constituent in the cell. However, the metal ion sequestration material may also be used in a partly soluble form that slowly “flows through” a cell carrying released metal ions with it, and is discharged from the cell with water and other byproducts. Use of an ion sequestration material in this manner may be on a continuous basis or on a periodic basis, for example, as part of a cell maintenance practice.

The metal chelating agent must be chemically and electrochemically stable in the environment of the fuel cell. In other words the chelating agent should not be destroyed by normal cell operation and the agent shouldn't interfere with the function of the proton transporting membrane or with other cell operations.

Other objects and advantages of the invention will become apparent from descriptions of preferred embodiments which follow.

### BRIEF DESCRIPTION OF THE DRAWINGS

FIG. 1 is a schematic view of an unassembled electrochemical fuel cell having a membrane electrode assembly (MEA) according to the invention.

FIG. 2 is a pictorial illustration of a cross-section of an MEA according to the invention.

FIG. 3 is a pictorial illustration of an MEA as in FIG. 2, and having graphite sheets.

FIG. 4 is a pictorial illustration showing a magnified view of a portion of the cathode side of FIG. 2.

FIG. 5 is an illustration of the two-dimensional structure of a functionalized 1,10-dibenzyl-1,10-diaza-18-crown-6 (DBAC), a metal chelating material used in illustrating the practice of the invention. The R groups on the dibenzyl groups are, for example; H, functional groups for attaching the crown ether to a polymer, or an attached polymer

FIG. 6 is a graph of reduction in frequency, in Δ Hertz, versus time of a quartz crystal coated with a film of DBAC, upon each addition of ferrous sulfate (FeSO₄, lower data plot) or cobaltous nitrate ((CoNO₃)₂, upper data plot) to the film.

### DESCRIPTION OF THE PREFERRED EMBODIMENT

The following description of the preferred embodiment(s) is merely exemplary in nature and is in no way intended to limit the invention, its application, or uses.

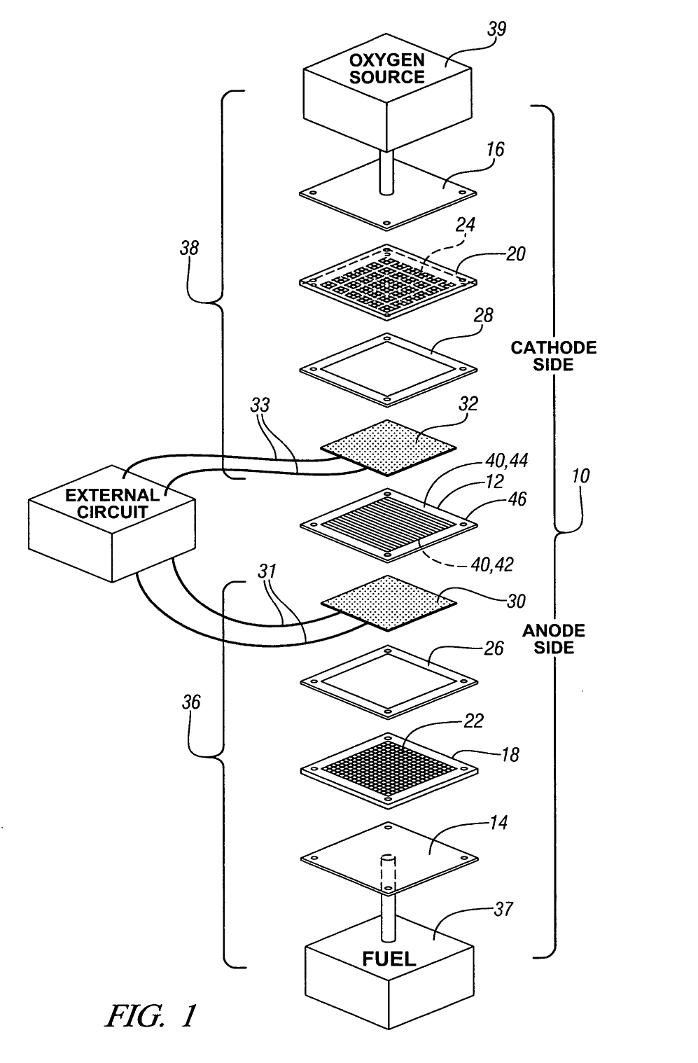

The invention is directed to forming electrodes and membrane electrode assemblies (MEAs) for use in fuel cells. Before describing the invention in detail, it is useful to understand the basic elements of an exemplary fuel cell and the components of the MEA. Referring to FIG. 1, an electrochemical cell 10 with a combination membrane electrolyte and electrode assembly 12 incorporated therein is shown in pictorial unassembled form. Electrochemical cell 10 is constructed as a fuel cell. However, the invention described herein is applicable to electrochemical cells generally. Electrochemical cell 10 comprises stainless steel endplates 14, 16, graphite blocks 18, 20 with openings 22, 24 to facilitate gas distribution, gaskets 26, 28, carbon cloth current collectors 30, 32 with respective connections 31, 33 and the membrane electrolyte and electrode assembly 12. The two sets of graphite blocks, gaskets, and, current collectors, namely 18, 26, 30 and 20, 28, 32 are each referred to as respective gas and current transport means 36, 38. Anode connection 31 and cathode connection 33 are used to interconnect with an external circuit, which may include other fuel cell elements in electrical parallel or series connection.

Electrochemical fuel cell 10 includes gaseous reactants, one of which is a fuel supplied from fuel source 37, and another is an oxidizer supplied from source 39. The gases from sources 37, 39 diffuse through respective gas and current transport means 36 and 38 to opposite sides of the MEA 12. Respectively, 36 and 38 are also referred to as electrically conductive gas distribution media.

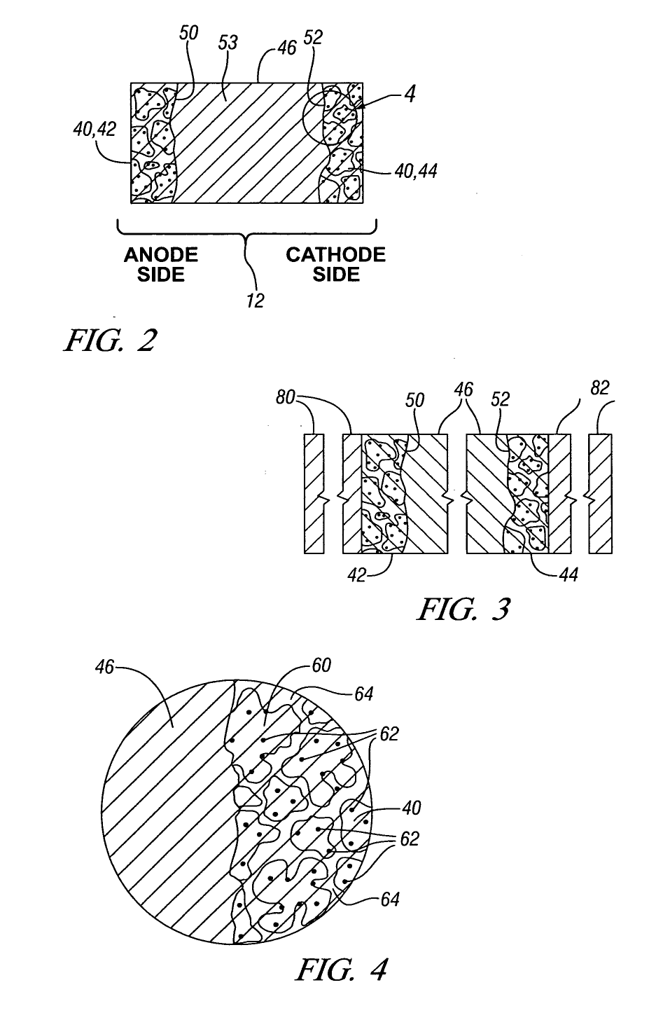

FIG. 2 shows a schematic view of the assembly 12 according to the present invention. Referring to FIG. 2, porous electrodes 40 form anode 42 at the fuel side and cathode 44 at the oxygen side. Anode 42 is separated from cathode 44 by a solid polymer electrolytic (SPE) membrane 46. SPE membrane 46 provides for ion transport to facilitate reactions in the fuel cell 10. The electrodes of the invention provide proton transfer by intimate contact between the electrode and the ionomer membrane to provide essentially continuous polymeric contact for such proton transfer. Accordingly, the MEA 12 of cell 10 has membrane 46 with spaced apart first and second opposed surfaces 50, 52, a thickness or an intermediate membrane region 53 between surfaces 50, 52. Respective electrodes 40, namely anode 42 and cathode 44 are well adhered to membrane 46, at a corresponding one of the surfaces 50, 52.

In one embodiment, respective electrodes 40 (anode 42, cathode 44) further comprise respective first and second Teflon® coated (polytetrafluoroethylene coated, impregnated) graphite sheets 80, 82, at respective sides of membrane 46. (FIG. 3) The anode active material 42 is disposed between the first surface 50 of the membrane and the first sheet 80; the cathode active material 44, is disposed between the second surface 52 and the second sheet 82. Each Teflon® coated sheet 80, 82 is about 7.5 to 13 mils thick.

As shown in FIG. 4, each of the electrodes 40 are formed of a corresponding group of finely divided carbon particles 60 supporting very finely divided catalytic particles 62 and a proton conductive material 64 intermingled with the particles. It should be noted that the carbon particles 60 forming the anode 42 may differ from the carbon particles 60 forming the cathode 44. In addition, the catalyst loading at the anode 42 may differ from the catalyst loading at the cathode 44. Although the characteristics of the carbon particles and the catalyst loading may differ for anode 42 and cathode 44, the basic structure of the two electrodes 40 is otherwise generally similar, as shown in the enlarged portion of FIG. 4 taken from FIG. 2.

In order to provide a continuous path to conduct H⁺ ions to the catalyst 62 for reaction, the proton (cation) conductive material 64 is dispersed throughout each of the electrodes 40, is intermingled with the carbon and catalytic particles 60,62 and is disposed in a plurality of the pores defined by the catalytic particles. Accordingly, in FIG. 4, it can be seen that the proton conductive material 64 encompasses carbon and catalytic particles 60, 62.

The solid polymer electrolyte membrane (PEM) of the fuel cell is a well-known ion conductive material. Typical PEMs and MEAs are described in U.S. Pat. Nos. 6,663,994, 6,566,004, 6,524,736, 6,521,381, 6,074,692, 5,316,871, and 5,272,017, each of which is attached hereto and made a part hereof, and each of which is assigned to General Motors Corporation.

The PEM is formed from ionomers and the method of forming membranes from ionomers is well known in the art. Ionomers (i.e., ion exchange resins) are polymers containing ionic groups in the structures, either on the backbone or side chain. The ionic groups impart ion exchange characteristics to the ionomers and PEM.

Ionomers can be prepared either by polymerizing a mixture of ingredients, one of which contains an ionic constituent, or by attaching ionic groups onto non-ionic polymers.

One broad class of cation exchange, proton conductive resins is the so-called sulfonic acid cation exchange resins, which rely on hydrated sulfonic acid groups for conducting protons. The preferred PEMs are perfluorinated sulfonic acid types. These membranes are commercially available. For example, Nafion® the trade name used by E.I. DuPont de Nemours & Co. Others are sold by Asahi Chemical and Asahi Glass Company, etc. PEMs of this type are made from ionomers obtained by copolymerizing tetrafluoroethylene (TFE) and perfluoro vinyl ether (VE) monomer containing sulfonyl fluoride, followed by a post-treatment that converts sulfonyl fluorides into sulfonic acid groups. Examples of VE monomers are:

CF₂═CFOCF₂CF(CF₃)OCF₂CF₂SO₂F and CF₂═CFOCF₂CF₂SO₂F

The components of cell 10 are prone to degradation or decomposition through attack by peroxide anions and radicals, which are unwanted but inherently generated in operation of the cell 10. These oxidizing species are generated concurrently with the reduction of oxygen on the cathode side of the MEA. They may also be generated on the anode side of the MEA because of transport of oxygen through the polymer electrolyte membrane.

In view of the presence of these unwanted chemically oxidizing species, it has been proposed to provide an oxide/peroxide radical scavenging component in the fuel cell such as hydroquinone or other suitable chemical species to mitigate or consume peroxide contaminants. This approach to protection of an MEA containing fuel cell is disclosed in co-pending patent application U.S. Ser. No. 10/929,190, filed Aug. 30, 2004, by the inventors of this invention and assigned to the assignee of this invention. And in view of the likely presence of fluoride anions in the cell environment, it has been proposed to provide a fluoride anion-scavenging component such as a suitable azacrown moiety in the fuel cell. This approach to protection of an MEA containing fuel cell is disclosed in co-pending patent application GP-305212 by the inventors of this invention and assigned to the assignee of this invention.

In one aspect of the first related disclosure, the MEA portion of the cell includes at least one constituent in ion-transfer relationship with the contaminant peroxide, where the constituent prevents, or at least inhibits, decomposition of one or more cell components by the contaminant peroxide.

For example, the PEM may comprise polymer molecules that incorporate peroxide consuming or storing functional groups. In another aspect, at least one of the first and/or second electrode(s) comprises a polymer constituent that includes peroxide consuming or storing functional groups. Such peroxide mitigating functional groups may be selected radical scavengers and substances that decompose peroxides. In a further aspect, the constituent prevents degradation of one or more other cell component(s), such as gasket, current collector sheets, Teflon® supports and the like. In yet another aspect, the constituent is an additive that is included in the cell in the form of a dispersed solid or a liquid. Examples of such additives are radical scavengers and substances that decompose peroxides.

Realistically, it is unlikely that the hydroquinones or other peroxide scavengers will capture and degrade all of the peroxides formed over the operating lifetime of a fuel cell powered vehicle. Thus, the possibility remains that some peroxide attack of fluorine containing polymers of the cell membrane or electrodes will occur with the release of fluoride anions. This is the reason for the second related disclosure identified above.

It remains likely that fluoride anions will migrate through the electrolyte membrane and into contact with the cathode and anode and react with and degrade metallic catalyst particles carried on these electrodes. The fluoride ions promote the corrosion of any base metal, M, in the fuel cell catalysts, such as Pt₃M (M=Fe, Co, Ni, Cr etc.) and therefore deteriorate the catalyst performance. And the fluoride ions can attack metal plates used as current collectors or a metal case containing the cell(s). Moreover, the released metal ions (iron, nickel, chromium, and cobalt) have two other deleterious effects: (i) they cross-link the ionomeric units in Nafion® and thus reduce the ability of the ion conducting channels to transport protons, and (ii) they (mostly iron) promote unwanted oxidation reactions.

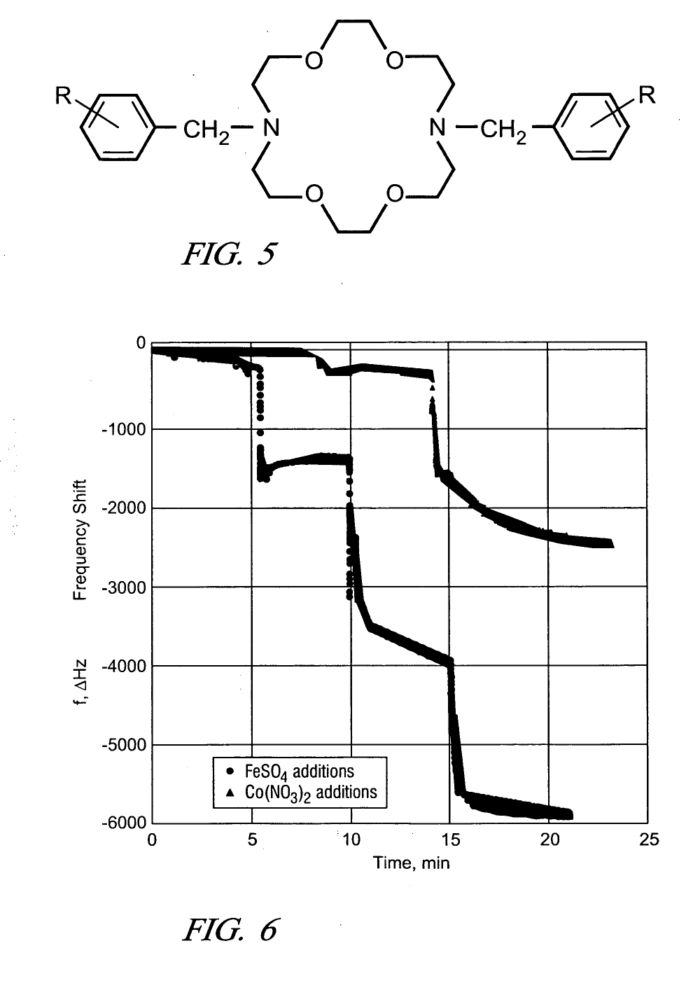

Accordingly, metal ion binding moieties are preferably incorporated into polymer species of the polymer electrolyte-electrodes environment to sequester these metal ions and prevent their deleterious side effects. A practice of the invention will be illustrated with the example of a crown ether, 1,10-dibenzyl-1,10-diaza-18-crown-6. A two-dimensional structural formula for this crown ether is shown in FIG. 5. The formula is generalized with R groups on the benzyl groups to indicate H, functional groups such as for attachment to a polymer, or an attached polymer.

A film of 1,10-dibenzyl-1,10-diaza-18-crown-6 was solvent cast onto an Au—Ti coated quartz crystal (resonant frequency: 10 MHz) of a [Model RQCM-1] quartz crystal microbalance. The crown ether was dissolved in acetone. The acetone was evaporated and the material was dried with an IR lamp and washed several times with doubly distilled deionized water prior to each experiment. Measurements were performed in a cell containing 40 mL of doubly distilled deionized water containing 2.2 mg Nafion (5% solution in water-alcohol), in order to adjust the solution pH to a value ranging between 2 and 3. Fe²⁺ or Co²⁺ metal cations were then introduced into the solutions through successive additions of 10 mg FeSO₄ or Co(NO₃)₂, respectively (three additions of Fe²⁺ and two additions of Co²⁺).

The graph of FIG. 6 shows that DBAC absorbs ferrous ions and cobaltous ions from aqueous solution because the frequency of the vibration of the crown ether coated crystal decreased as the crown ether trapped more of the metal ions. This is a suitable laboratory test for evaluating candidate metal ion binding agents.

Other examples of candidate crown ethers and an azacrown include: dicyclohexyl-18-crown-6, dibenzo-18-crown-6, dibenzo-21-crown-7, dibenzo-24-crown-8, dibenzo-30-crown-10, and 7,16-dibenzyl-1,4,10,12-tetraoxa-7,16-diazacyclooctadecane.

Crown ethers in containing one or more sulfur atoms (thia-crowns) in the crown ring are also known to have a strong propensity for binding iron ions. These thia-crowns as well as the crown ethers can be chemically modified for incorporation into the polymer molecules of the electrolyte membrane or into other polymers for fixing the metal ion-chelating agent in the cell environment.

Thus anchored to a polymer constituent in the cell, the crown-containing moieties will sequester metal cations that have been released into the water-polymer electrolyte environment and limit their availability for interference with cell conductivity and promoting internal cell oxidants. The strategy is to anchor a suitable number of crown moieties to some portion of the membrane or sandwiching electrode material compositions to trap the metal ions over a suitable period of operating time of the cell. Another approach is to provide for periodic addition of a suitable small amount of crown-moieties to the fuel cell and allowing the crown-metal ion complex to be washed out by the wastewater.

Crown ethers and their aza-analogues and thia-analogues constitute a substantial family of compounds. Those members having a large enough crown structure to sequester a metal cation may be adapted for use in the practice of this invention. In order to attach a suitable crown containing moiety to a PEM substrate or other polymer substrate it will usually be necessary to chemically modify a peripheral portion of the crown molecule to, for example, attach a vinyl group for incorporation into the polymer chain of the PEM or attach a basic group for bonding to a pendant acid functionality. Obviously other chemical modification strategies may be exploited to attach the crown moieties or other metal ion trapping species to PEM molecules or to other constituents of the electrode-electrolyte environment.

The metal ion-scavenging constituents of this invention may be used alone or in combination with scavenging chemical groups or species for other unwanted materials in the electrolytic cell. As mentioned above, it has been proposed to incorporate in the cell scavenging materials for peroxides and other strongly oxidizing species that sever fluoride ions from polymer constituents of the cell in the first instance. It has also been proposed to incorporate scavenging materials for fluoride anions. Obviously, metal ion scavengers can be used in combination with such destroyers or capturers of oxidizers or fluoride anions detrimental to electrolytic cell function and life.

The practice of the invention has been illustrated by examples of preferred embodiments which are not intended to limit this invention.

1. A fuel cell that produces water as a byproduct and comprising:
a polymer electrolyte membrane sandwiched between an anode and a cathode where at least one of the polymer membrane, the anode, or the cathode comprise fluorine atoms susceptible to conversion to fluoride anions in water in operation of the cell;
a metal component wettable by the fluoride anions in operation of the cell to produce unwanted metal ions; and
a metal ion sequestering agent.

2. A fuel cell as recited in claim 1 further comprising a polymer electrolyte with fluorine atoms distributed along the chains of the polymer molecules.

3. A fuel cell as recited in claim 1 further comprising a polymer electrolyte with fluorine atoms distributed along the chains of the polymer molecules and moieties of a metal ion sequestering agent attached to the polymer molecules.

4. A fuel cell as recited in claim 1 further comprising an anode or cathode with a polymeric constituent with fluorine atoms distributed along the chains of the polymer molecules.

5. A fuel cell as recited in claim 1 further comprising an anode or cathode with a polymeric constituent with fluorine atoms distributed along the chains of the polymer molecules and moieties of a metal ion sequestering agent attached to the polymer molecules.

6. A fuel cell as recited in claim 1 in which the metal ion-sequestering agent comprises crown moieties.

7. A fuel cell as recited in claim 2 in which the metal ion-sequestering agent comprises crown moieties.

8. A fuel cell as recited in claim 3 in which the metal ion-sequestering agent comprises crown moieties.

9. A fuel cell as recited in claim 4 in which the metal ion-sequestering agent comprises crown moieties.

10. A fuel cell as recited in claim 5 in which the metal ion-sequestering agent comprises crown moieties.

11. A fuel cell that produces water as a byproduct and comprising:
a polymer electrolyte membrane sandwiched between an anode and a cathode where at least one of the polymer membrane, the anode, or the cathode comprise fluorine atoms, and where chemical oxidizing species to are formed in operation of the cell that convert some of the fluorine atoms to fluoride anions in water;
a metal component wettable by the fluoride anions in operation of the cell to produce unwanted metal ions; and
at least one of a sequestering agent for chemical oxidizing species or a sequestering agent for fluoride anions and
a metal ion sequestering agent.
